(19) United States
(12) Patent Application Publication
(10) Pub. No.: US 2025/0054246 A1
(43) Pub. Date: Feb. 13, 2025

(54) GAZE-MEDIATED AUGMENTED REALITY INTERACTION WITH SOURCES OF SOUND IN AN ENVIRONMENT

(71) Applicant: Google LLC, Mountain View, CA (US)

(72) Inventors: Ruofei Du, San Francisco, CA (US); Alex Olwal, Santa Cruz, CA (US)

(21) Appl. No.: 18/707,075

(22) PCT Filed: Oct. 14, 2022
(86) PCT No.: PCT/US2022/078119

§ 371 Date: May 2, 2024

Related U.S. Application Data
(60) Provisional application No. 63/263,415, filed on Nov. 2, 2021.

(51) Int. Cl. G06T 19/00; G06F 3/01

(52) U.S. Cl. CPC G06T 19/006; G06F 3/013; G06F 3/017

(57) ABSTRACT

A user can interact with sounds and speech in an environment using an augmented reality device. The augmented reality device can be configured to identify objects in the environment and display messages beside the object that are related to sounds produced by the object. For example, the messages may include sound statistics, transcripts of speech, and/or sound detection events. The disclosed approach enables a user to interact with these messages using a gaze and a gesture.

### CROSS-REFERENCE TO RELATED APPLICATION

This application claims priority to U.S. Provisional Patent Application No. 63/263,415, filed on Nov. 2, 2021, the disclosure of which is incorporated by reference herein in its entirety.

### FIELD OF THE DISCLOSURE

The present disclosure relates to augmented reality devices configured to identify and interact with a source of sound in an environment.

### BACKGROUND

Augmented reality (AR) devices, such as AR glasses, can help a user understand an environment by providing the user with AR information related to the environment. For example, an AR device may present messages, in the form of transcripts or translations to help a user hear, understand, and/or record the sounds. These messages may be presented/updated in real time as sounds are emitted. These messages may be presented as static messages with no means for interaction.

### SUMMARY

In at least one aspect, the present disclosure generally describes a method. The method includes registering a sound source using an AR device. The method further includes detecting by the AR device, a sound from the registered sound source (e.g., using audio-based localization). The method further includes displaying, by the AR device, a highlight around the registered sound source. The method further includes detecting a gaze of a user using the AR device. The method further includes determining that the gaze of the user is within a threshold distance of the highlighted sound source using the AR device. The method further includes detecting a length-of-time of the gaze within the threshold distance is greater than a first threshold using the AR device. The method further includes displaying the message including at least one interactive feature in response to the length-of-time being greater than the first threshold.

The proposed solution in particular relates to a method comprising registering, by an augmented reality (AR) device, a sound source; detecting, by the AR device, a sound from the registered sound source; highlighting, by the AR device, the registered sound source (in a virtual environment display by the AR device); detecting, by the AR device, a gaze of a user; determining, by the AR device, that a distance between a focus point of the gaze and the highlighted sound source is less than a threshold distance; detecting, by the AR device, a length-of-time a length-of-time the distance of the focus point and the highlighted sound source being less than the threshold distance is greater than a threshold time; and displaying, in response to the length-of-time being greater than the threshold time, a message associated with the sound source, the message including at least one interactive feature.

One aspect of the proposed solution thus also relates to AR glasses configured to perform a disclosed method.

Registering the sound source may include storing at least one of localization information (i.e., data on the location of the sound source globally and/or locally with respect to the AR device) and device type information (i.e., data indicating a type, such as appliance, machinery, gadget, medical equipment, alarm, or tool, or model of the sound source) for the sound source in a database of the AR device or accessible by the AR device so that after registration the registered sound source may be identified and localized by the AR device automatically within the virtual environment.

In a possible implementation the sound source is a non-smart device (e.g., a faucet) that is not communicatively coupled to the AR device and/or a network (i.e., is not configured to electronically communicate with the AR device and/or has no connectivity/wireless communication interface).

For example, the registering of the sound source may include (i) detecting a gaze and an additional pre-determined user action to select the sound source, (ii) mapping a location of the selected sound source in a global space using at least one of audio-based localization, gaze-based localization, or communication-based localization, and (ii) generating the threshold distance based on the location of the sound source.

An audio-based localization may, for example, include obtaining signals from an array of microphones of the AR device, the signals corresponding to (e.g., originating or resulting from) a sound from the sound source; and comparing the signals from the array of microphones and/or times of arrival of the signals from the array of microphones to map the location of the sound source.

A gaze-based localization may, for example includes sensing, by the AR device, a gaze of the user, and determining a focus point of the gaze of the user to map the location of the sound source. Sensing the gaze may include sensing the position of one or both eyes of the user (i.e., wearer of AR device). The positions of the eyes may help to determine a focus point of a gaze of the user. For example, when a gaze of a user is in a direction of the sound source the focus point of that gaze may be estimated to be the location of the sound source. The focus point may include determining pupil positions of both eyes and then determining a binocular vergence of theoretical gaze vectors extending from the pupils.

A communication-based localization may, for example, include communicating, by the AR device, with the sound source using wireless communication, and obtaining location information from the wireless communication to map the location of the sound source. For example, AR device may be configured to compute a round-trip-time of a wireless communication signal between the AR device and the sound source. The round-trip-time (i.e., time of flight) may be used to derive a range between the AR device and the sound source (i.e., two-way ranging). Further, in some implementations multiple receivers of the AR glassed may be used to determine a time-difference of arrival of a wireless communication signals from the sound source to each receiver in order to compute an angle between the AR device and the sound source.

In another aspect, the present disclosure generally describes an augmented reality (AR) device. The AR device includes a microphone array that is configured to capture sounds from a sound source. The AR device further include a heads-up display that is configured to display messages corresponding to the sounds from the sound source in a field of view of a user. The AR device further include a gaze sensor configured to monitor one (or both) eyes of the user to determine a gaze of the user. The AR device further includes a wireless module configured to communicate with a smart device. The AR device further include a camera configured to capture images of the field of view of the user. The AR device further include a processor that is in communication with the microphone array, the heads-up display, the gaze sensor, the wireless modules, and the camera. The processor is configured to (i) detect a location corresponding to the sounds, (ii) determine that the location corresponds to a registered sound source, (iii) highlight the registered sound source in the AR display, (iv) detect a gaze directed to the highlighted sound source for a period of time, (v) display, in response to the detected gaze, a message associated with the sound source, and (vi) detect a gaze and an additional pre-determined user action (e.g., gaze-plus-gesture) from the user to interact with the message.

For example, the proposed solution may thus relate to augmented reality (AR) glasses comprising a microphone array configured to capture sounds from a sound source, a heads-up display configured to display messages corresponding to the sounds from the sound source in a field of view of a user, a gaze sensor configured to monitor one or both eyes of the user to determine a gaze of the user, a wireless module configured to communicate with a smart device, a camera configured to capture images of the field of view of the user, and a processor in communication with the microphone array. The heads-up display, the gaze sensor, the wireless module, the camera, and the processor may then be configured to (i) detect a location corresponding to the sounds, (ii) determine that the location corresponds to a registered sound source, (iii) highlight the registered sound source in the AR display, (iv) detect a gaze of the user directed to the highlighted sound source for a period of time, (v) display, in response to detected gaze (and the period of time exceeding a time threshold), a message associated with the sound source, and (vi) detect a gaze and an additional pre-determined user action from the user to interact with the message.

One aspect of the proposed solution thus also relates to a method comprising (i) detecting a location corresponding to sounds of a sound source in a field of view of a user of AR glasses, (ii) determining that the location corresponds to a registered sound source, (iii) highlighting the registered sound source in an AR display, (iv) detecting a gaze of the user directed to the highlighted sound source for a period of time, (v) displaying, in response to detected gaze (and the period of time exceeding a time threshold), a message associated with the sound source, and (vi) detecting a gaze and an additional pre-determined user action from the user to interact with the message.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 illustrates a possible interaction with a sound source according to a possible implementation of the present disclosure.

FIG. 2 illustrates various AR interactions with an environment according to a possible implementation of the present disclosure.

FIG. 3 is a flowchart illustrating a method for message interaction according to a possible implementation of the present disclosure.

FIG. 4 is a detailed flowchart of a sound source registration process according to a possible implementation of the present disclosure.

FIG. 5 is a detailed flowchart of a message triggering process according to a possible implementation of the present disclosure.

FIG. 6 is a detailed flowchart of a message interaction process according to a possible implementation of the present disclosure.

FIG. 7 illustrates a system block diagram of the AR glasses according to a possible implementation of the present disclosure.

FIG. 8 is a perspective view of AR glasses according to a possible implementation of the present disclosure.

FIG. 9 is a flowchart of a method for generating an interactive message for a sound source in an AR environment according to a possible implementation of the present disclosure.

FIG. 10 is a flowchart of a method for triggering a function associated with an interactive message for a sound source according to a possible implementation of the present disclosure.

The components in the drawings are not necessarily to scale relative to each other. Like reference numerals designate corresponding parts throughout the several views.

### DETAILED DESCRIPTION

The present disclosure describes AR devices and methods to interact with AR messages related to sounds and/or speech in an environment (i.e., global environment). The interaction can be based on a gaze of a user combined with at least one additional user action, in particular a user action resulting from a movement of at least one extremity (e.g., arm(s), hand(s), finger(s)), at least one eye lid, at least one eye of the user and/or from a voice command. The interaction can thus, for example, be based on a gaze of a user combined with blink of a user, an eye movement of the user, a gesture of the user, such as a finger point or a hand gesture, and/or a voice command. A user can use this gaze-plus approach to register the sources of sound in the global environment that are of interest to a user. A later gaze (i.e., a subsequent gaze a later point in time after registration) on a registered sound source can trigger a message (e.g., caption, menu, controls, etc.) displayed with the sound source on an AR display (e.g., heads-up display (HUD)). The user can also implement the gaze-plus approach to interact with the message. For example, a message may include at least one interactive feature configured to perform a function when triggered by a gaze-plus user action, i.e., a gaze combined with an additional user action, such as a gesture (resulting in a gaze-plus-gesture) or a voice command (resulting in a gaze-plus-command). The disclosed systems and methods may have the technical effect of improving a performance or usefulness of an AR interface by providing sound related messages that have interactive features. The interactive messages may advantageously provide additional information and/or function to an AR environment.

An environment may include sounds from a variety of sources. For example, sounds from smart devices may present opportunities for AR messages to be presented. As used herein a smart device is an electronic device that is connected with other devices or networks using wireless communication protocols (e.g., Bluetooth, WiFi, 5G, Ultra-Wideband, etc.). Smart devices used in the environment may include (but are not limited to) phones, tablets, computers, smart thermostats, smart doorbells, smart locks, smart refrigerators, smartwatches, and the like. The smart devices may be configured to generate sounds, and a user viewing a smart device with an AR device may have AR messages presented that are related to the sounds generated by the smart device. For example, AR glasses viewing a smart speaker that is playing music may have a transcript of the music presented as an AR message. The AR message may be updated in real-time (i.e., on the fly) with the music. These sound related AR messages may help users that are deaf or hard-of-hearing (i) understand that the smart device is making a sound and (ii) interpret the sounds from the smart. One problem with AR messages displayed in real time is that they provide no means for interaction. The disclosed approach includes real-time AR messages with interactive features. These interactive features may further enable a user (e.g., a deaf or hard-of-hearing user) variously interact with the AR messages.

The disclosed techniques may enable a variety of possible interactions with AR messages. One possible interaction includes reviewing the speech-to-text result of a specific sound source. Another possible interaction includes changing a font color, font style, and/or font size of a transcription of a specific sound source. Another possible interaction includes changing the translation language of a specific sound source. Another possible interaction includes changing a frequency of sound alerts. Another possible interaction includes triggering a summary of spoken information. Another possible interaction includes recording new data for sound detection of a specific sound source to improve a sound detection algorithm. Another possible interaction includes saving a transcription to a note stored in local memory or in a network (i.e., cloud) memory. Another possible interaction includes changing a layout of a translation (e.g., dual language side-by-side, sentence-by-sentence) of a transcript. Another possible interaction includes viewing statistics of a sound (e.g., water usages from a water faucet). Another possible interaction includes answering a call from a transcript (e.g., “call from Bob”). Another possible interaction includes pausing and/or playing music. Another possible interaction includes displaying sound and speech visualization (e.g., waveforms, spectrograms, etc.).

An environment also includes a vast number of potential sound sources that are not smart devices. For example, sounds from living entities may create sounds in an environment. Such sounds may include speech from a person, crying from a baby, and a bark from a dog. AR messages created in relation to these living entities may help a deaf or hard-of-hearing user respond/interact more effectively with the living entities (e.g., AR message alerting the user of a crying baby).

An environment (e.g., home environment) may also include sounds from appliances (oven/stove, dishwasher, refrigerator, clothes dryer, washing machine, doorbell, sink, shower, bath, grill, counter-top appliance, etc.), machinery (pump, clock, garage door, HVAC, telephone, etc.), electronic gadgets (radio, mp3 player, etc.), medical equipment (e.g., CPAP machine, air purifier, ventilator, wheelchair, etc.), alarms (e.g., smoke alarms, alarm clocks, etc.), tools (e.g., saw; vacuum cleaner, etc.), and the like. These objects (i.e., things) may be referred to herein as “non-smart devices” because they are not configured to communicate with the AR device and/or a network. AR message created in relation to these non-smart devices may help a deaf or hard-of-hearing user respond to sounds created in the environment created by the non-smart devices.

One problem with displaying AR messages for all of the sound sources described thus far is in the volume of possible messages. The present disclosure describes systems and methods to limit the possible number of AR messages displayed. For example, in one possible implementation, only sound sources that are registered by a user will present AR messages. In another implementation, the display of AR messages can be triggered by sounds. For example, a dripping faucet can create an AR message, whereas a non-dripping faucet will not. These limiting criteria can be combined. For example, an AR message will only be displayed for a registered sound source when it is making a sound. In another example, the sound detected from a sound source may trigger a user to register the sound source. For example, a sound from a dripping faucet may trigger a user to register the faucet to collect data on water usage that the user may interact with later. Generally speaking, the proposed solution may in particular facilitate registering a non-smart sound source for later user interaction within a virtual environment and/or facilitate user interaction with one or more sound sources in a virtual environment irrespective of the sound source being a smart device, a non-smart device or a living entity.

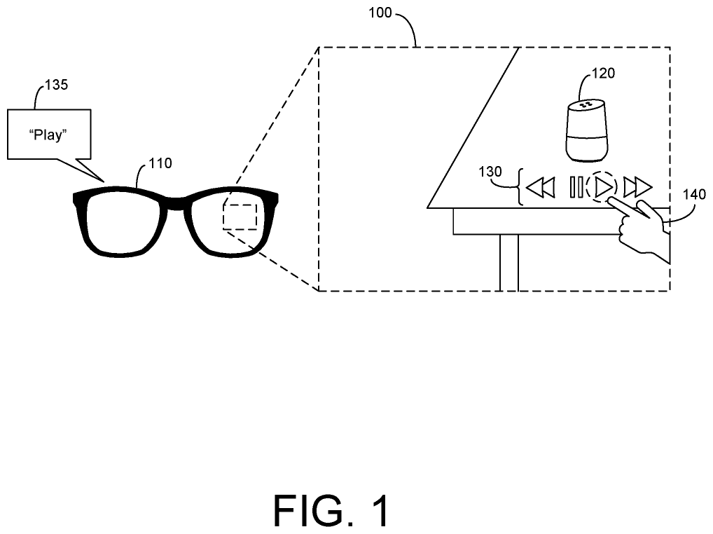

FIG. 1 illustrates a possible interaction with a sound source. As shown, a user views a global environment 100 using AR glasses 110. The global environment 100 includes a registered sound source (i.e., smart speaker 120). The AR glasses are configured to monitor a gaze of a user. When a focus point of the gaze of the user is within a threshold distance of the registered sound source for more than a threshold length-of-time, a message corresponding to the sound source is presented on the AR display of the AR glasses. The message presented on the AR display is interactive. As shown, a gaze of the user focused on the smart speaker 120 for a period of time may trigger the AR glasses 110 to display a set of virtual controls 130 for the smart speaker. The virtual controls 130 are configured for interaction. This interaction may be carried out by a user via a gaze-plus-action. For example, the user may gaze at a particular control (i.e., play button) to select (i.e., highlight) the play button. While the user gazes at the play button an additional user action confirming and triggering the interaction may be performed. For example, while gazing at the play button (i.e., while the play button is highlighted), a user may speak a command 135 (e.g., “play”) to activate the play button. The AR glasses 110 may detect the gaze-plus-command and trigger an application causing the smart speaker to play. In another example, while gazing at the play button (i.e., while the play button is highlighted), a user may point 140 at the play button in the AR environment. The AR glasses 110 may detect the gaze-plus-point and trigger an application causing the smart speaker to play. A sound source is not limited to a smart device and the messages are not limited to controls.

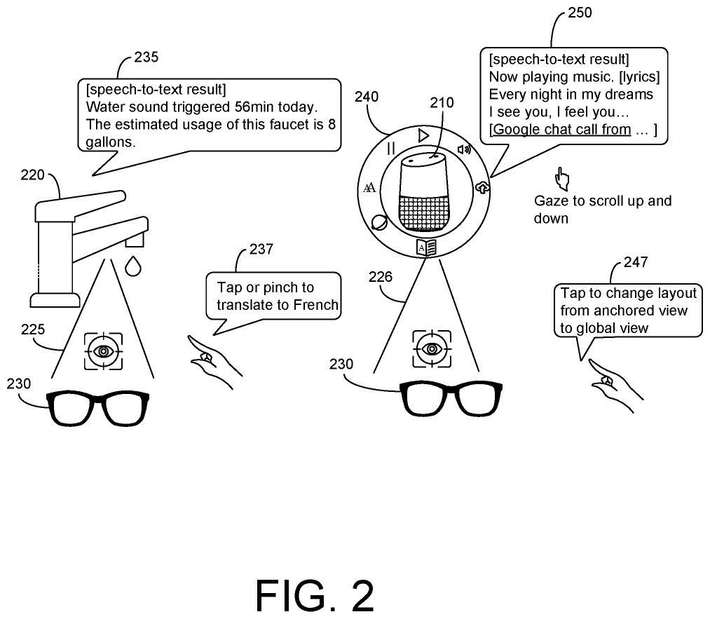

FIG. 2 illustrates an environment (e.g., a smart home environment). The environment includes smart devices (e.g., hub, smart speaker, smart doorbell, smart TV, etc.) that can be configured to perform functions, such as playing music, videos, and/or handling phone calls. The smart device(s) may be further configured to generate speech in reply to questions or other user-initiated interactions. Some users (e.g., hard-of-hearing users, foreign language speakers) may wish to view text transcripts and/or text translations of this speech. AR glasses can be configured to trigger this speech, monitor this speech, and/or to present messages (e.g., captions, transcripts) based on this speech to help the user understand their environment. These messages may update (e.g., scroll) in real time as the speech occurs and may be configured for a user to interact with using AR.

FIG. 2 illustrates various AR interactions with an environment. As shown, the environment includes a smart device (e.g., smart speaker 210) having communication connectivity and a non-smart device (e.g., faucet 220) not having communication connectivity. The smart speaker 210 may be triggered by the AR glasses to respond with speech about the non-smart device. As shown, a first gaze 225 of the user that is directed to the faucet 220 may be detected by AR glasses 230. This first gaze 225 may trigger the smart speaker 210, which is coupled to the AR glasses, to report a voice message about the faucet. This voice message may be transcribed and displayed on the AR glasses 230 as a first transcript 235. The first transcript 235 may be interacted with by a user. For example, a tap/pinch 237 with a finger (or fingers) of a user on the first transcript 235 may translate the first transcript 235 to a different language (e.g., French). Later, a second gaze 226 of the user at the smart speaker 210 may be detected by the AR glasses 230 and trigger a menu 240 (e.g., graphical menu) to appear on the AR display when a user views the smart speaker 210. As shown, the menu 240) may be anchored to the smart speaker 210 in the AR environment. A tap 247 (finger point) of the user on the menu while the user gazes at the menu may trigger a function. For example, as shown, a gaze-plus-finger tap on a menu button may change the layout of the menu from the anchored view to a global view in the AR environment.

As shown in FIG. 2, the AR glasses may also be configured to transcribe music lyrics and an incoming call announcement in a second transcript 250 that is displayed to a user on the AR display. A user may interact with the second transcript using a gaze. For example, the lyrics may be scrolled up and down with a movement of the eye. Additionally, a user may interact with the second transcript using a gaze-plus-gesture (i.e., finger point) to answer the call.

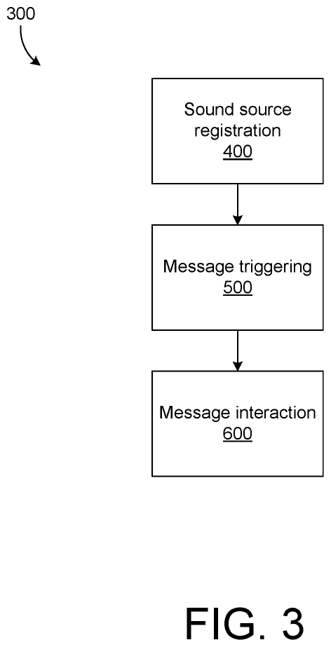

FIG. 3 is a flowchart illustrating a method (i.e., pipeline) for message interaction. A first stage (i.e., step, operation, process etc.) of the method can include a sound source registration process 400. An environment may include a variety of sound sources. By registering a sound source, an AR device may be configured to display messages about the sound source when triggered by a user and/or by a sound from the sound source. Sound sources may be smart devices configured to identify and localize their position in relative to the AR device automatically. Additionally, sound sources may be non-smart devices (e.g., faucets) that require a user's participation to register and identify the sound source.

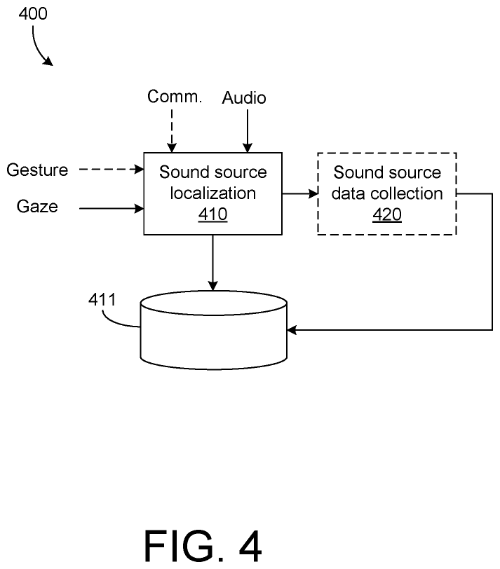

FIG. 4 is a detailed flowchart of a sound source registration process according to one possible implementation. For messages to appear physically anchored to the sound source in an AR environment it may be necessary to determine a location of the sound source in a global environment. In a possible implementation, a user may trigger a sound source localization process 410 using a gaze or a gaze-plus-gesture. For example, AR glasses may detect a gaze of a user on a non-smart device (e.g., faucet). This gaze may highlight the non-smart device in a user's view of the AR environment. A user may then tap the non-smart device or say “register” to initiate a sound source localization process 410. Alternatively, for a smart device, the sound source localization process 410 may be triggered automatically by communication between smart devices over a network. For example, a smart speaker can communicate wirelessly with the AR glasses to determine its relative position.

The sound source localization process 410 may include mapping a location of the selected sound source in a global space (e.g., physical environment) using any combination of audio-based localization, gaze-based localization, and communication-based localization. The sound source localization process 410 may further include generating a bounding box surrounding the sound source which can be compared to a gaze of a user to determine if a user is looking at the sound source. For example, when the gaze of the user is determined to be within the bounding box (i.e., within a threshold distance from a center of the bounding box), it may be concluded that the user is interested in the sound source. In other words, the boundaries of the bounding box may define one or more threshold distances to the sound source to which a focus point of a gaze can be compared to determine a user's intent.

As mentioned, mapping a location of a sound source (e.g., non-smart device) may include audio-based localization. Audio-based localization may include obtaining signals from a sound source using an array of microphones on the AR glasses. The microphones in the array can be arranged so that a direction of the sound source relative to the array (i.e., the glasses) may be determined. The direction of sounds from a sound source can be determined using a variety of techniques. For example, in one possible implementation, a time of arrival of a sound at each of the microphones in the microphone array may be determined and compared in order to calculate a direction of the sound source. In another possible implementation, a beam formed by the microphone array may be used to determine a direction of the sound source based on the relative amplitudes of the signals at each microphone in the microphone array.

Mapping a location of a sound source (e.g., non-smart device) may include gaze-based localization. Gaze-based localization may include sensing the position of one or both eyes of a user (i.e., wearer of AR glasses). The positions of the eyes may help to determine a focus point of a gaze of the user. The focus point may determine (or help determine) a location of a sound source. For example, when a gaze of a user is in a direction of the sound source (e.g., determined by audio-based localization) the focus point of that gaze may be estimated to be the location of the sound source. The focus point may include determining pupil positions of both eyes and then determining a binocular vergence of theoretical gaze vectors extending from the pupils.

Mapping a location of a sound source (e.g., smart device) may include communication-based localization. Communication-based localization may include the AR device digitally communicating with the sound source using wireless communication, such as ultra-wideband (UWB), Bluetooth, and/or Wifi. Location information may be obtained and/or derived from the wireless communication. This location information may be used to map the location of the sound source. For example, AR glasses may be configured to compute a round-trip-time of a UWB communication protocol between the AR glasses and a smart hub device. The round-trip-time (i.e., time of flight) may be used to derive a range between the two devices (i.e., two-way ranging). Further, in some implementations the multiple receivers may be used to determine a time-difference of arrival of a wireless signal to each receiver in order to compute an angle between the two devices.

Returning to FIG. 4, the sound source localization process 410 may include storing the location of the sound source in a database 411. The database may be local to the AR device or may be coupled to the AR device via a network (i.e., cloud). The sound source identification/location 410 may further trigger the AR glasses, or another device, to begin collecting data 420 about the sound source and storing the collected data in the database 411 as well. This data may include speech-to-text transcripts, sound statistics, and other data required for the messaging examples described previously.

Returning to FIG. 3, a second stage of the method for message interaction 300 can include a message triggering process 500. The AR glasses can be configured to sense a sound from the sound source. For example, audio detected by the AR glasses may localize a sound source in the environment. When the localization aligns with a registered sound source, the sound source may be visually highlighted (i.e., highlighted) in the users AR field of view. The AR glasses can be further configured to monitor a gaze of the user and a position of the AR glasses in the global environment in order to determine where (in the environment) the user is looking. When the gaze of the user remains fixed on a registered sound source for a period of time, the AR glasses may be triggered to display a message associated with the sound source. For example, a user's gaze on the highlighted sound source for a period of time may trigger message visualization (i.e., message display). The message can be a graphic (e.g., menu, graphical controls, etc.) or can be a transcript (e.g., song lyrics of music playing). In some implementations that message can be a highlight. The highlight may indicate to a user that the object is selected but that some additional gesture is necessary to perform a function. For example, a sound source may be highlighted and when a user finger points at the highlighted sound source a message may be displayed.

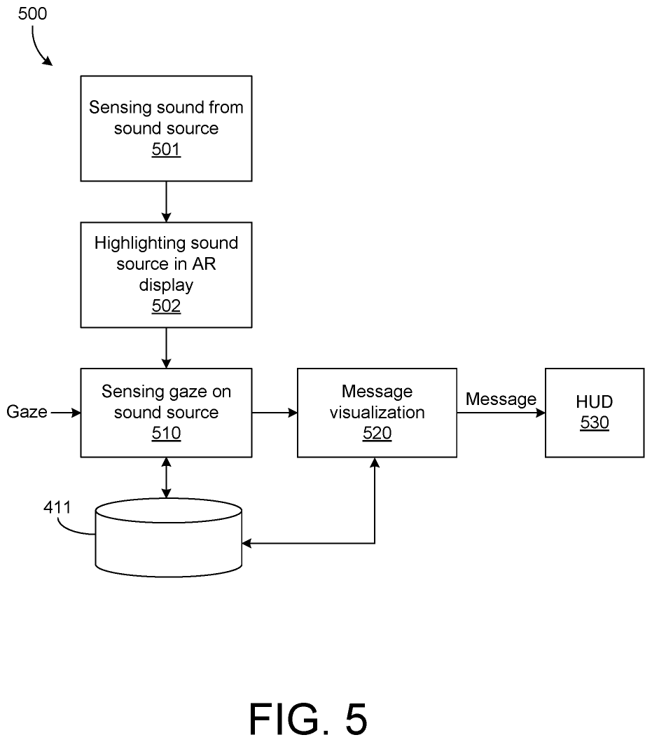

FIG. 5 is a detailed flowchart of a message triggering process according to a possible implementation. The message triggering process may include sensing a sound from a (registered) sound source 501. In a possible implementation this sound may trigger a highlight graphic (e.g., glimmer) to be presented with the sound source on the AR display. Sensing the sound from the sound source may include determining a location of the sound source from audio collected by a microphone array of the AR glasses. This location can be compared with stored locations of registered sound sources. When this location aligns with a location of a registered sound source, then the registered sound source may be highlighted 502 in the AR display. The message triggering process may include sensing a gaze of a user 510. The gaze of a user can be correlated with where the user's attention is directed. Accordingly, sensing the gaze of a user 510 may include detecting a focus point of a gaze of a user. For example, a gaze can be detected using gaze tracking sensors on a wearable device (e.g., AR glasses). Alternatively (or additionally), a gaze can be detected using sensor(s) directed at the eyes of a user (e.g., camera(s)). The gaze of the user may be compared with locations of registered sound sources. In particular, the gaze of the user may be compared with the location of the highlighted sound source. In a possible implementation, when the gaze of the user is within a threshold distance of the sound source for a length-of-time that is greater than a first threshold (i.e., time threshold), then a message visualization process 520 may be triggered. The message visualization process 520 may include generating a message for the sound source. The message may include collected data about the sound source that is retrieved from the database 411. The message visualization process 520 can further include displaying the message on a heads-up display of the AR device (e.g., on a lens of AR glasses). The message may be positioned on the display based on the mapped location of the sound source so that the message appears spatially associated with the sound source when a user views the sound source through the heads-up display (HUD 530). When the user's view changes, the message may follow the sound source. For example, if a user is not facing the sound source, then the message may not be displayed on the HUD 530. The message may be created and updated in real time.

Returning to FIG. 3, a third stage of the method for message interaction can include a message interaction process 600. The AR device (e.g., AR glasses) may be configured to monitor the user's eyes to detect a gaze of the user and to detect an additional user action, such as gesture of a user, to indicate an interaction with the message. The AR device may be further configured to perform a function when an interaction is detected.

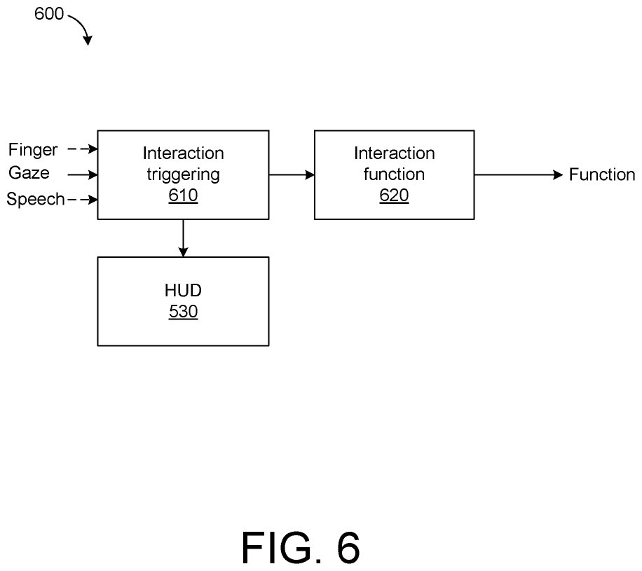

FIG. 6 is a detailed flowchart of a message interaction process 600 according to a possible implementation. The message interaction process 600 can include triggering an interaction with the message. The interaction triggering 610 may include detecting a gaze of the user on a portion (e.g., interactive feature) of the message. The interaction triggering 610 may further include detecting an additional user action, e.g., a gesture, such as a finger/hand gesture (e.g., point, pinch, etc.), or a spoken command (i.e., voice command). In a possible implementation the interaction triggering 610 can include detecting a gaze-plus-gesture to select an interactive feature (e.g., link, control, word, etc.) in the message. The message interaction process 600 can further include performing an interaction function 620 when triggered. An interaction function may alter the message, provide additional information about the message, or change an operating condition of a device. Some possible functions from message interaction (i.e., interaction functions) are listed below in TABLE 1.

TABLE 1
POSSIBLE FUNCTIONS FROM MESSAGE INTERACTION

Change font, color, style, and/or size of a message
Summarize a message
Save/Recall a message
Translate a message
Change a layout of a translation (dual-language side-by-side/sentence-by-
sentence)
Search a message for an item (e.g., word, name)
Search information (e.g., definition) related to items (e.g., words) in a
message
Answer a call or chat
Control a sound source function
Visualize or play sounds corresponding to the message

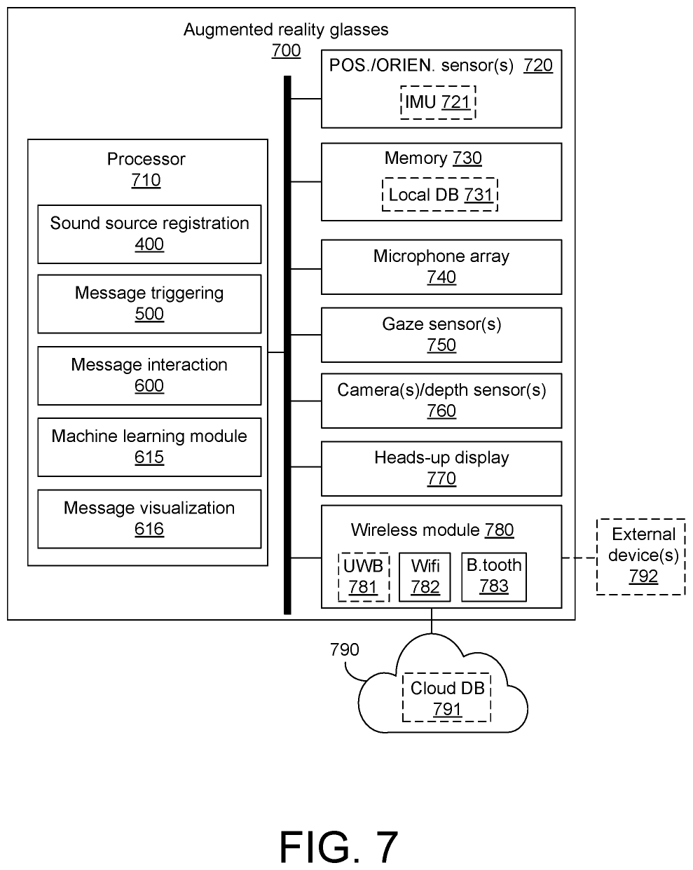

FIG. 7 illustrates a system block diagram of the AR glasses according to a possible implementation. As shown, the AR glasses 700 can include position/orientation sensor(s) 720 configured to detect the position/orientation of the AR glasses relative to a global coordinate system. For example, the position/orientation sensors(s) 720 may include an inertial measurement unit (IMU 721). The IMU 721 may include accelerometers to measure velocity and/or acceleration, gyroscopes to measure rotation and/or rotational rate, and/or magnetometers to establish a direction of movement. Data from these sensors can be combined to track the relative position/orientation of the AR glasses. As shown in FIG. 7, the AR glasses 700 can further include camera(s) and/or depth sensor(s) 760 directed to a field of view that overlaps with a user's natural field of view. As described previously, the camera(s) may include a camera configured to capture visual (i.e., RGB) images of the field of view (FOV) and a camera (e.g., depth sensor) configured to capture depth images of the FOV. The positioning data from the IMU 721 and the images from the camera(s) 760 may be used in a simultaneous localization and mapping (SLAM) process configured to track the position of the AR glasses 700 relative to a global environment. For example, the SLAM process can identify feature points in images captured by the camera(s) 760. The feature points can be combined with the IMU data to estimate a pose (i.e., position/orientation) of the AR glasses 700 relative to a global environment.

The AR glasses 700 can further include sensors to estimate positions (i.e., point locations, x,y,z) of objects, devices, people, animals, etc. around the user. As shown in FIG. 7, the AR glasses 700 can further include gaze sensor(s) 750 (e.g., eye-directed camera(s)) configured to sense attributes (e.g., pupil position) of an eye (or eyes) of a user. The attributes may be processed to determine a direction or point at which a user is looking (i.e., a gaze of the user). When the gaze of the user is combined with the pose of the user, an interaction between the user and the environment may be understood. For example, data from gaze sensors may be used to help determine the direction and/or position of a device or person in the global environment.

As shown in FIG. 7, the AR glasses 700 can further include a microphone array 740 configured to sense sounds from an environment. Further, the microphone array 740 may be configured to determine directions of sounds from an environment, as shown in FIG. 7. Data from the microphone array may be used to help determine the direction and/or position of a device or person in the global environment.

The AR glasses 700 can further include wireless modules 780. The wireless modules may include various circuits (i.e., modules) configured to communicate in a variety of wireless protocols. For example, the wireless module may include ultra-wideband (UWB) module 781, a wifi module 782, and/or a Bluetooth module 783. The wireless modules 780 may be configured to wireless couple the AR glasses 700 to external device(s) 792 and/or to a network 790 (i.e., cloud) in order to exchange data. For example, the external device(s) 792 can include a mobile computing device (e.g., mobile telephone) that, through a wireless communication link, can help process data from the AR glasses. In another example, the network 790 can include a cloud database 791 that, through a wiles communication link, can help store and retrieve data with the AR glasses. The wireless modules may also be able to determine a position of the AR device relative to an external device. For example, an UWB module 781 may be able to determine a relative range between two devices using a round trip time (RTT) of a signal in a communication between the two devices. Further, when the UWB module includes an array of receivers, a relative direction between the two devices may be determined based on a times of arrival of the signal at the receivers. Accordingly, data from the wireless modules 780 may be used to help determine the direction and/or position of a device or person in the global environment.

The AR glasses 700 further includes a processor 710 that can be configure by software to perform a plurality of processes (i.e., a pipeline) required for AR message interaction. The plurality of processes can include sound source registration process 400, message triggering 500, message interaction 600, machine learning 615, and message visualization 616. The plurality of processes may be embodied as programs stored in (and retrieved from) a memory 730 (e.g., from a local database 731). The disclosed approach can combine data and/or functions from these processes to provide anchored messages for presentation on a heads-up display 770 of the augmented reality glasses 700.

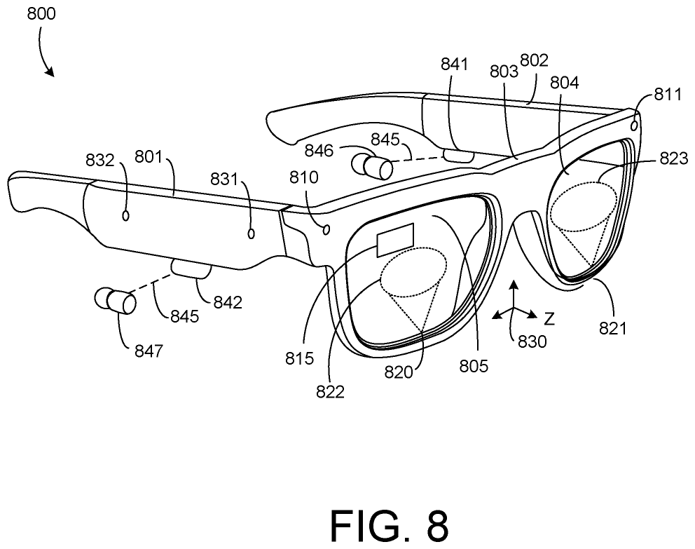

FIG. 8 is a perspective view of AR glasses according to a possible implementation of the present disclosure. The AR glasses 800 are configured to be worn on a head and face of a user. The AR glasses 800 include a right earpiece 801 and a left earpiece 802 that are supported by the ears of a user. The AR glasses further include a bridge portion 803 that is supported by the nose of the user so that a left lens 804 and a right lens 805 can be positioned in front a left eye of the user and a right eye of the user respectively. The portions of the AR glasses can be collectively referred to as the frame of the AR glasses. The frame of the AR glasses can contain electronics to enable function. For example, the frame may include a battery, a processor, a memory (e.g., non-transitory computer readable medium), and electronics to support sensors (e.g., cameras, depth sensors, etc.), and interface devices (e.g., speakers, display, network adapter, etc.).

The AR glasses 800 can include a FOV camera 810 (e.g., RGB camera) that is directed to a camera field-of-view that overlaps with the natural field-of-view of the user's eyes when the glasses are worn. In a possible implementation, the AR glasses can further include a depth sensor 811 (e.g., LIDAR, structured light, time-of-flight, depth camera) that is directed to a depth-sensor field-of-view that overlaps with the natural field-of-view of the user's eyes when the glasses are worn. Data from the depth sensor 811 and/or the FOV camera 810 can be used to measure depths in a field-of-view (i.e., region of interest) of the user (i.e., wearer). In a possible implementation, the camera field-of-view and the depth-sensor field-of-view may be calibrated so that depths (i.e., ranges) of objects in images from the FOV camera 810 can be determined, where the depths are measured between the objects and the AR glasses.

The AR glasses 800 can further include a display 815. The display may present AR data (e.g., images, graphics, text, icons, etc.) on a portion of a lens (or lenses) of the AR glasses so that a user may view the AR data as the user looks through a lens of the AR glasses. In this way, the AR data can overlap with the user's view of the environment.

The AR glasses 800 can further include an eye-tracking sensor. The eye tracking sensor can include a right-eye camera 820 and a left-eye camera 821. The right-eye camera 820 and the left-eye camera 821 can be located in lens portions of the frame so that a right FOV 822 of the right-eye camera includes the right eye of the user and a left FOV 823 of the left-eye camera includes the left eye of the user when the AR glasses are worn.

The AR glasses 800 can further include a plurality of microphones (i.e., 2 or more microphones). The plurality of microphones can be spaced apart on the frames of the AR glasses. As shown in FIG. 8, the plurality of microphones can include a first microphone 831 and a second microphone 832. The plurality of microphones may be configured to operate together as a microphone array that has a beam of sensitivity directed in a particular direction relative to a coordinate system 830 of the AR glasses 800.

As shown in FIG. 8, the AR glasses may further include a left speaker 841 and a right speaker 842 configured to transmit audio (e.g., beamformed audio) to the user. Additionally, or alternatively, transmitting audio to a user may include transmitting the audio over a wireless communication link 845 to a listening device (e.g., hearing aid, earbud, etc.). For example, the AR glasses may transmit audio (e.g., beamformed audio) to a left wireless earbud 846 and to a right earbud 847.

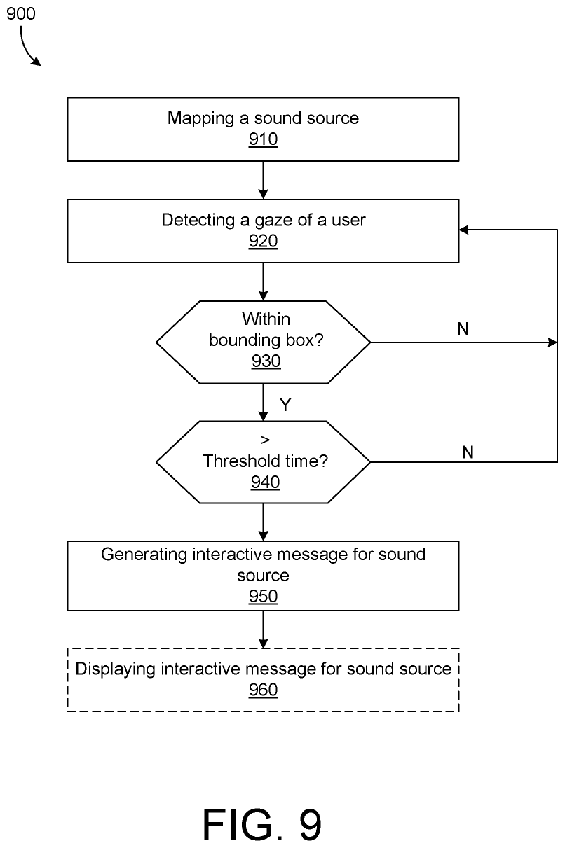

FIG. 9 is a flowchart of a method for generating an interactive message for a sound source in an AR environment according to a possible implementation of the present disclosure. The method 900 includes mapping 910 a sound source using AR glasses. The mapping 910 may use any combination of audio-based localization, gaze-based localization, and communication-based localization. The mapping 910 may further include creating a bounding box that virtually surrounds and is virtually anchored to the object in an AR environment. The method 900 further includes detecting 920 a gaze of a user. Detecting the gaze of the user may include sensing the eyes of the user and/or the position/orientation of the AR glasses. If (i) the gaze of the user is within the bounding box created for the sound source 930 and (ii) the gaze remains within the bounding box for a period of time greater than a threshold 940, then an interactive message for the sound source can be generated 950. The interactive message can then be displayed 960 on a display of the AR glasses. When the two criteria for message generation are not met the method may continue to monitor the gaze of the user.

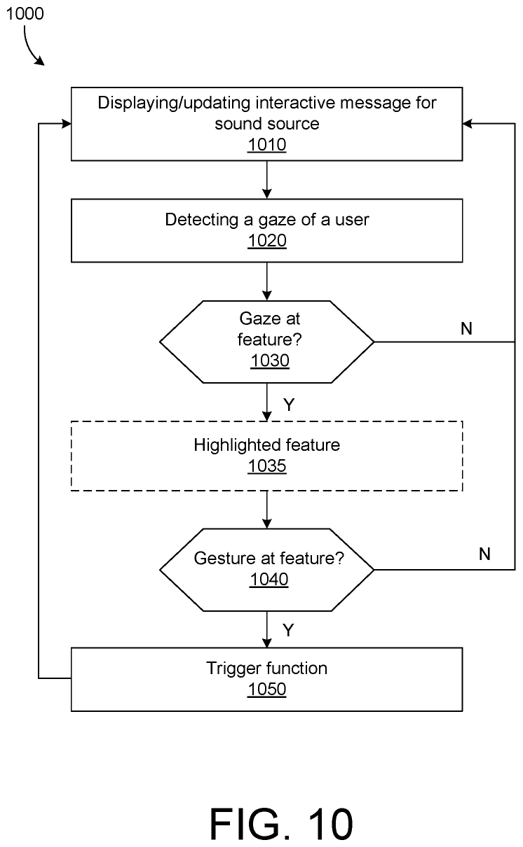

FIG. 10 is a flowchart of a method for triggering a function associated with an interactive message for a sound source according to a possible implementation of the present disclosure. In the method 1000, an interactive message is displayed/updated 1010 in an AR environment. The interactive message includes features configured for interaction (e.g., interactive features). The method 1000 includes detecting 1020 a gaze of the user. When (i) the user's gaze at the feature is detected 1030 and (ii) a user's gesture at the feature is detected 1040, then a function related to the message and/or the sound source may be triggered 1050. Otherwise, the message for the sound source can continue to update and display 1010. In some implementations when the user's gaze at the feature is detected the feature can be highlighted 1035 in the AR environment so that the user is prompted to complete the selection with a gesture.

In the specification and/or figures, typical embodiments have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a.” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
detecting, by a computing device, a sound from a sound source;
detecting a gaze of a user;
determining that a distance between a focus point of the gaze and the sound source is less than a threshold distance for greater than a threshold time; and
displaying, in response to the determining, a message including at least one interactive feature.

2. The method according to claim 1, wherein the determining that a distance between a focus point of the gaze and the sound source is less than a threshold distance includes:
determining whether the focus point of the gaze is within a bounding box surrounding the sound source.

3. The method according to claim 1, wherein the sound source is a non-smart device.

4. The method according to claim 1, further including registering the sound source, the registering including:
detecting a gaze and an additional pre-determined user action to select the sound source;
mapping a location of the selected sound source in a global space using at least one of audio-based localization, gaze-based localization, or communication-based localization; and
generating the threshold distance based on the location of the sound source.

5. The method according to claim 4, wherein audio-based localization includes:
obtaining signals from an array of microphones of the computing device, the signals resulting from a sound from the sound source; and
comparing the signals from the array of microphones and/or times of arrival of the signals from the array of microphones to map the location of the sound source.

6. The method according to claim 4, wherein gaze-based localization includes:
sensing, by the computing device, a gaze of the user; and
determining a focus point of the gaze of the user to map the location of the sound source.

7. The method according to claim 4, wherein communication-based localization includes:
communicating, by the computing device, with the sound source using wireless communication; and
obtaining location information from the wireless communication to map the location of the sound source.

8. The method according to claim 7, wherein the wireless communication is ultra-wideband (UWB).

9. The method according to claim 7, wherein the wireless communication is Bluetooth.

10. The method according to claim 7, wherein the wireless communication is WiFi.

11. The method according to claim 1, further including:
detecting a gaze and an additional pre-determined user action to select the at least one interactive feature, the selected interactive feature triggering a function.

12. The method according to claim 11, wherein detecting a gaze and an additional pre-determined user action to select the interactive feature includes:
gazing at the interactive feature while pointing a finger at the interactive feature.

13. The method according to claim 11, wherein detecting a gaze and an additional pre-determined user action to select the interactive feature includes:
gazing at the interactive feature while speaking a command.

14. The method according to claim 11, wherein the message is a transcript, the at least one interactive feature are words in the transcript, and the function is providing a definition or a translation of a word in the transcript.

15. The method according to claim 11, wherein the message is graphic, the at least one interactive feature are virtual buttons in the graphic, and the function is changing an operating condition of a device.

16. A computing device, comprising:
a microphone array configured to capture sounds from a sound source;
a heads-up display configured to display messages corresponding to the sounds from the sound source in a field of view of a user;
a gaze sensor configured to monitor one or both eyes of the user to determine a gaze of the user;
a wireless module configured to communicate with a device;
a camera configured to capture images of the field of view of the user; and
a processor in communication with the microphone array, the heads-up display, the gaze sensor, the wireless module, and the camera, the processor configured to:
detect a location corresponding to the sounds;
determine that the location corresponds to the sound source;
display a highlight for the sound source in the computing display;
detect a gaze of the user directed to the highlighted sound source for a period of time;
display, in response to detected gaze, a message associated with the sound source; and
detect a gaze and an additional pre-determined user action from the user to interact with the message.

17. The computing device according to claim 16, wherein the processor is further configured to:
detect a gaze and an additional pre-determined user action to select the sound source for registration; and
mapping a location of the selected sound source in a global space using any combination of audio-based localization, gaze-based localization, and communication-based localization.

18. The computing device according to claim 16, wherein the message includes an interactive feature and to interact with the message includes:
the gaze and the additional pre-determined user action select the interactive feature, the selection of the interactive feature triggers a function.

19. The computing device according to claim 16, wherein the message includes a text transcript or a text translation that is updated in real time with the sounds.

20. The computing device according to claim 18, wherein the message includes a graphical menu or graphical controls.

21. The computing device according to claim 16, wherein the sound source is a smart device.

22. The computing device according to claim 16, wherein the sound source is a non-smart device not having communication connectivity.
